(19) United States
(12) Patent Application Publication
(10) Pub. No.: US 2026/0145497 A1
(43) Pub. Date: May 28, 2026

(54) WATERPROOF HARD COVER

(71) Applicant: WENZHOU TIANMAO AUTOMOBILE PARTS CO., LTD, WENZHOU (CN)

(72) Inventor: Lanhua CAI, WENZHOU (CN)

(21) Appl. No.: 18/959,607

(22) Filed: Nov. 26, 2024

(51) Int. Cl. B60J 7/14; B60J 7/00

(52) U.S. Cl. CPC B60J 7/141; B60J 7/0084

(57) ABSTRACT

The present invention discloses a waterproof hard cover comprising a front bar, a first rotating shaft, a second rotating shaft, a rear bar, a side rail system, a large plate fixing system, a wrench fixing system and a plurality of plates; the first rotating shaft left rod blocking hook rotationally cooperates with a first rotating shaft intermediate rod round hook, the first rotating shaft intermediate rod round hook and the first rotating shaft left rod blocking hook are provided with first rotating shaft intermediate rod water outlet between the two hooks, the first rotating shaft intermediate rod C-shaped groove mates with the concave surface of the first rotating shaft left rod.

### FIELD

This invention is relevant to pickup rear cover, especially a waterproof hard cover.

### BACKGROUND

Pickup truck is an essential type of automobile market, pickup truck is a vehicle with sedan front end and cab with open van compartment, which is characterized by both sedan-like comfort and strong power, moreover, it has better cargo capacity and adaptability to bad road surface than sedan. Currently the most common pickup truck models are two-row pickup truck, pickup trucks can be used as a special vehicle, multi-use vehicles, government vehicles and commercial vehicles, it can also be used as a family car, used for cargo, travel and rental and other uses. The so-called “pickup truck” is a hybrid of cars and trucks, with the expansion of the scale of modification enthusiasts, pickup truck modification is becoming more and more modification enthusiasts keen on the category.

Existing pickup truck covers on the market are categorized into soft and hard covers. In the case of hard covers, it is common to connect multiple panels through a system of rotating shafts, which makes them prone to leakage at the rotating shaft connection.

### SUMMARY

In order to solve the above problems of the existing technology, the technical solution adopted in the invention is as follows:

A waterproof hard cover comprises a front bar, a first rotating shaft, a second rotating shaft, a rear bar, a side rail system, a large plate fixing system, a wrench fixing system and a plurality of plate bodies;

The front bar, the first rotating shaft, the second rotating shaft and the rear bar form a transverse frame, the side bar system forms a longitudinal frame, the transverse frame and the longitudinal frame compose the skeleton of the cover, the large plate fixing system and the wrench fixing system are connected to the plate bodies;

The first rotating shaft comprises a first rotating shaft left rod, a first rotating shaft intermediate rod, a first rotating shaft right rod, a first rotating shaft left rod joint, a first rotating shaft intermediate joint, a first rotating shaft right rod joint, a first rotating shaft right rod right joint spacer, a first rotating shaft intermediate rod right joint spacer, and a first rotating shaft left rod joint spacer;

The first rotating shaft left rod is provided with a first rotating shaft left rod blocking hook and a first rotating shaft left rod concave surface, the first rotating shaft intermediate rod is provided with a first rotating shaft intermediate rod round hook, a first rotating shaft intermediate rod water outlet and a first rotating shaft intermediate rod C-groove, the first rotating shaft left rod blocking hook is rotatingly mated with the first rotating shaft intermediate rod round hook, a first rotating shaft intermediate rod water outlet is provided between the first rotating shaft intermediate rod round hook and the first rotating shaft left rod blocking hook, the first rotating shaft intermediate rod C-shaped groove is adapted to the concave surface of the first rotating shaft left rod;

The first rotating shaft intermediate joint is provided with a first rotating shaft intermediate joint semi-circular hook, the first rotating shaft left rod joint is provided with a first rotating shaft left rod joint lower water outlet, a first rotating shaft left rod joint circular arc channel and a first rotating shaft left rod joint water outlet cavity, the first rotating shaft intermediate joint semi-circular hook is rotationally connected to the first rotating shaft left rod joint circular arc channel (both the first rotating shaft intermediate joint semi-circular hook and first rotating shaft left rod joint circular arc channel are arc-shaped, the first rotating shaft intermediate joint semi-circular hook rotates inside the first rotating shaft left rod joint circular arc channel, the center portion of the semi-circular hook of the first rotating shaft intermediate rod joint is connected with the water outlet cavity of the first rotating shaft left rod joint for draining water) and discharges the water from the lower water outlet of the first rotating shaft left rod joint through the water outlet cavity of the first rotating shaft left rod joint. The first rotating shaft intermediate rod water outlet, the first rotating shaft intermediate joint semi-circular hook and the first rotating shaft left rod joint water outlet cavity are connected to form a drainage channel.

A waterproof hard cover comprises a front bar, a first rotating shaft, a second rotating shaft, a rear bar, a side rail system, a large plate fixing system, a wrench fixing system and a plurality of plate bodies;

The front bar, the first rotating shaft, the second rotating shaft and the rear bar form a transverse frame, the side bar system forms a longitudinal frame, the transverse frame and the longitudinal frame compose the skeleton of the cover, the large plate fixing system and the wrench fixing system are connected to the plate bodies;

The first rotating shaft comprises a first rotating shaft left rod, a first rotating shaft intermediate rod, a first rotating shaft right rod, a first rotating shaft left rod joint, a first rotating shaft intermediate joint, a first rotating shaft right rod joint, a first rotating shaft right rod right joint spacer, a first rotating shaft intermediate rod right joint spacer, and a first rotating shaft left rod joint spacer;

Further, the first rotating shaft left rod is provided with a first rotating shaft left rod round hook and a first rotating shaft left rod concave surface, the first rotating shaft intermediate rod is provided with a first rotating shaft intermediate rod blocking hook, a first rotating shaft intermediate rod water outlet and a first rotating shaft intermediate rod C-groove, the first rotating shaft left rod round hook is rotatingly mated with the first rotating shaft intermediate rod blocking hook, a first rotating shaft intermediate rod water outlet is provided between the first rotating shaft intermediate rod blocking hook and the first rotating shaft left rod round hook, the first rotating shaft intermediate rod C-shaped groove is adapted to the first rotating shaft left rod concave surface;

The first rotating shaft left joint is provided with a first rotating shaft intermediate joint semi-circular hook, the first rotating shaft left rod joint is provided with a first rotating shaft left rod joint lower water outlet, a first rotating shaft left rod joint circular arc channel and a first rotating shaft left rod joint water outlet cavity, the first rotating shaft intermediate joint semi-circular hook is rotationally connected to the first rotating shaft left rod joint circular arc channel, and discharges the water from the lower water outlet of the first rotating shaft left rod joint through the water outlet cavity of the first rotating shaft left rod joint. The first rotating shaft intermediate rod water outlet, the first rotating shaft intermediate joint semi-circular hook, and the first rotating shaft left rod joint water outlet cavity are connected to form a drainage channel.

Further, the first rotating shaft intermediate joint comprises a first rotating shaft intermediate joint beveled surface, a first rotating shaft intermediate joint semi-circular hook, a first rotating shaft intermediate joint rubber-through groove, a first rotating shaft intermediate joint bottom plane, a first rotating shaft intermediate joint insertion vertical portion, a first rotating shaft intermediate joint insertion transverse portion, a first rotating shaft intermediate joint eave, a first rotating shaft intermediate joint screw hole, and a first rotating shaft intermediate joint protrusion;

There are two first rotating shaft intermediate joint rubber-through grooves, the two first rotating shaft intermediate joint rubber-through grooves are respectively located on both sides of the first rotating shaft intermediate joint, the first rotating shaft intermediate joint beveled surface is located on the front side of the first rotating shaft intermediate joint, the first rotating shaft intermediate joint insertion vertical portion and the first rotating shaft intermediate joint insertion transverse portion are inserted into the profile for withstanding the transverse force and the longitudinal force, the first rotating shaft intermediate joint bottom plane is flat, the first rotating shaft intermediate joint screw hole is used for connecting screws, the first rotating shaft intermediate joint eaves are used for covering the gap between the profile and the first rotating shaft intermediate joint, the first rotating shaft intermediate joint is provided with first rotating shaft intermediate joint protrusions on both sides.

Further, the first rotating shaft left rod joint comprises a first rotating shaft left rod joint first plug, a first rotating shaft left rod joint eave, a first rotating shaft left rod joint second plug, a first rotating shaft left rod joint beveled surface, a first rotating shaft left rod joint screw mounting hole, and a first rotating shaft left rod joint concave portion;

Both sides of the first rotating shaft left rod joint are provided with first rotating shaft left rod joint concave portions, the first rotating shaft left rod joint first plug is used for connecting transverse profiles, the first rotating shaft left rod joint second plug is used for connecting longitudinal profiles, the first rotating shaft left rod joint screw is used for connecting screws, the first rotating shaft left rod joint beveled surface is provided on the front side of the first rotating shaft left rod joint, the first rotating shaft left rod joint eave is used to cover the gap between the profile and the joint.

Further, the first rotating shaft intermediate joint protrusions are staggered with the first rotating shaft left rod joint concave portion.

The first rotating shaft intermediate joint protrusions are in correspondence with the first rotating shaft left rod joint concave portion and cooperate with each other.

Further, the first rotating shaft right rod right joint spacer, the first rotating shaft intermediate rod right joint spacer and the first rotating shaft left rod joint spacer are provided on the lower side of the first rotating shaft left rod joint, the first rotating shaft intermediate joint and the first rotating shaft right rod joint;

The first rotating shaft right rod right joint spacer is provided with a first rotating shaft right rod right joint spacer outlet notch, the first rotating shaft right rod right joint spacer outlet notch said is used for draining water in cooperation with the first rotating shaft left rod joint lower water outlet;

Further, the center of the first rotating shaft intermediate rod right joint spacer is provided with a first rotating shaft intermediate rod intermediate joint spacer protrusion, the center of the first rotating shaft right rod right joint spacer is provided with a first rotating shaft intermediate rod right joint spacer concave, the first rotating shaft intermediate rod intermediate joint spacer protrusion is adapted to the first rotating shaft intermediate rod right joint spacer concave.

Further, both of the large plate fixing system and the wrench fixing system are provided with a slider, the slider is provided with a vertical notch, a protrusion, a transverse channel, a side protrusion and a semicircular channel, there are two side protrusions, the two side protrusions are provided at both ends of the slider, the side protrusions are used to clamp the profiles and to increase the damping, the semi-circular channel is used to clamp with the T-rod, the semi-circular channel is used for restricting the short side of the T-rod, the vertical notch is for restricting the long side of the T-rod, the vertical notch is for restricting the long side of the T-rod.

The beneficial effect of the present invention is that this utility model, through the improvement of the rotating shaft on the cover as well as the joint, not only makes the rotating shaft more stable when rotating, but also makes it a better drainage effect, avoiding water leakage at the rotating shaft.

### BRIEF DESCRIPTION OF THE DRAWINGS

FIG. 1 is a usage schematic diagram I of the present invention.

FIG. 2 is a usage diagram II of the present invention.

FIG. 3 is a structural schematic diagram I of the present invention.

FIG. 4 is a cross-sectional view in the direction of A-A in FIG. 3.

FIG. 5 is a partially enlarged view I of part B in FIG. 4.

FIG. 6 is a schematic view of a first rotating shaft in the present invention I.

FIG. 7 is a schematic view of a first rotating shaft joint in the present invention.

FIG. 8 is a schematic diagram II of the structure of the first rotating shaft in the present invention.

FIG. 9 is a partially enlarged view of part C in FIG. 8.

FIG. 10 is a structural schematic diagram I of the first rotating shaft intermediate joint.

FIG. 11 is a structural schematic diagram II of the first rotating shaft intermediate joint.

FIG. 12 is a structural schematic diagram III of the first rotating shaft intermediate joint.

FIG. 13 is a structural schematic diagram IV of the first rotating shaft intermediate joint.

FIG. 14 is a structural schematic diagram I of the first rotating shaft left rod joint.

FIG. 15 is a structural schematic diagram II of the first rotating shaft left rod joint.

FIG. 16 is a structural schematic diagram III of the first rotating shaft left rod joint.

FIG. 17 is a structural schematic diagram II of the present invention.

FIG. 18 is a partially enlarged view of part D in FIG. 17.

FIG. 19 is a structural schematic diagram III of the present invention.

FIG. 20 is a partially enlarged view of part E in FIG. 19.

FIG. 21 is a structural schematic diagram I of a wrench fixing system.

FIG. 22 is a structural schematic diagram II of the wrench retention system.

FIG. 23 is a structural schematic diagram IV of the present invention.

FIG. 24 is a partially enlarged view of part F of FIG. 23.

Figures: 1—Front bar; 2—First rotating shaft; 201—First rotating shaft left rod; 2011—First rotating shaft left rod blocking hook; 2012—First rotating shaft left rod concave surface; 201A1—First rotating shaft left rod round hook; 201A2—First rotating shaft left rod concave; 202—First rotating shaft intermediate rod; 2021—First rotating shaft intermediate rod round hook; 2022—First rotating shaft intermediate rod water outlet; 202A1—First rotating shaft intermediate rod blocking hook; 202A2—First rotating shaft intermediate rod water outlet; 202A3—First rotating shaft intermediate rod C-groove; 2023—First rotating shaft intermediate rod C-groove; 203—First rotating shaft right rod; 204—First rotating shaft intermediate rod joint; 2041—First rotating shaft intermediate rod joint first plug; 2042—First rotating shaft intermediate rod joint lower water outlet; 2043—First rotating shaft left rod joint eave; 2044—First rotating shaft left rod joint second plug; 2045—First rotating shaft left rod joint arc channel; 2046—First rotating shaft left rod joint water outlet cavity; 2047—first rotating shaft left rod joint beveled surface; 2048—First rotating shaft left rod joint screw mounting holes; 2049—First rotating shaft left rod joint concave portion; 205—First rotating shaft intermediate joint; 2051—First rotating shaft intermediate joint beveled surface; 2052—First rotating shaft intermediate joint semi-circular hook; 2053—First rotating shaft intermediate joint rubber-through groove; 2054—First rotating shaft intermediate joint bottom plane; 2055—First rotating shaft intermediate joint insertion vertical portion; 2056—First rotating shaft intermediate joint insertion transverse portion ; 2057—First rotating shaft intermediate joint eave; 2058—First rotating shaft intermediate joint screw hole; 2059—First rotating shaft intermediate joint protrusion; 206—First rotating shaft right rod joint; 207—First rotating shaft right rod right joint spacer; 2071—First rotating shaft right rod right joint spacer outlet notch; 2072—First rotating shaft intermediate shaft right joint spacer concave; 208—First rotating shaft intermediate rod right joint spacer; 2081—first rotating shaft intermediate rod intermediate joint spacer protrusion; 209—First rotating shaft left rod joint spacer; 3—Second rotating shaft; 4—Rear Bar; 5—Side rail system; 6—Large board fixing system; 7—Wrench fixing system; 701—Slider; 7011—Vertical notch; 7012—Protrusions; 7013—Transverse channel; 7014—Side protrusions; 7015—Semi-circular channel; 702—T-rod; 8—Plate body; 101—Front bar clamps.

### DETAILED DESCRIPTION OF THE DISCLOSURE

The following instruction further explains the invention's concrete implementation method.

In order to enable a clearer understanding of the objects mentioned above, features and advantages of the present invention, the invention is described in detail below in connecting with the accompanying Figure and specific embodiments. It should be noted that the embodiments of the present invention and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

The specific embodiments of the present invention will be described in detail below in connecting with the accompanying Figure. It should be understood that the specific embodiments described herein are intended only to illustrate and explain the present invention and not to limit it.

### Embodiment 1

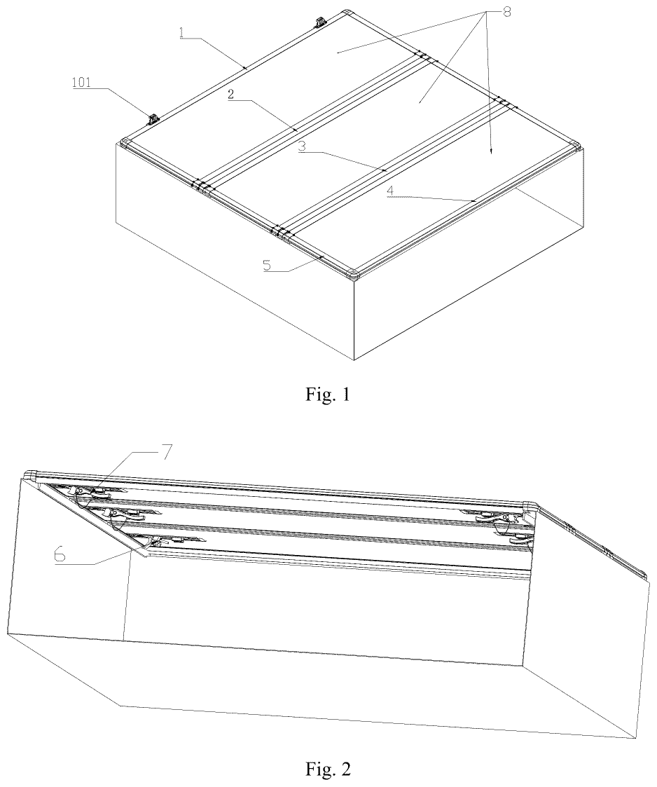

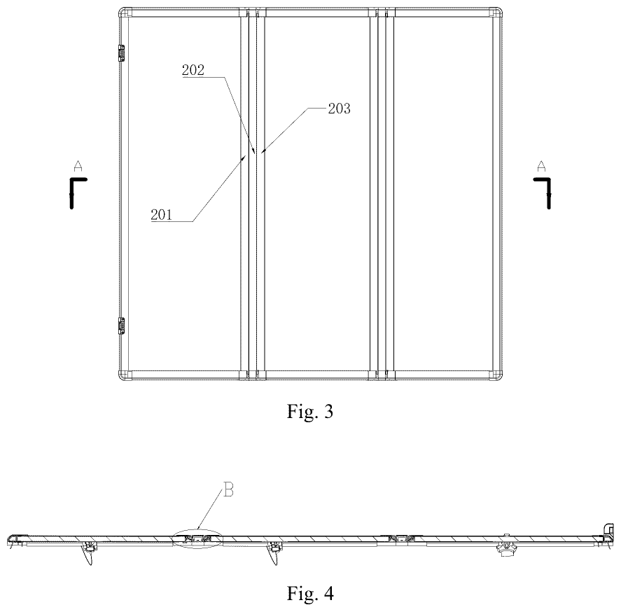

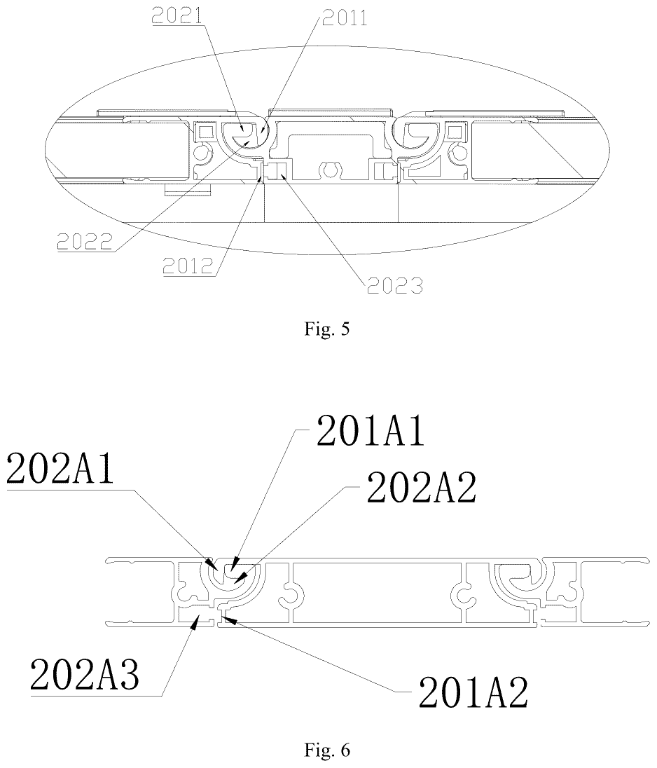

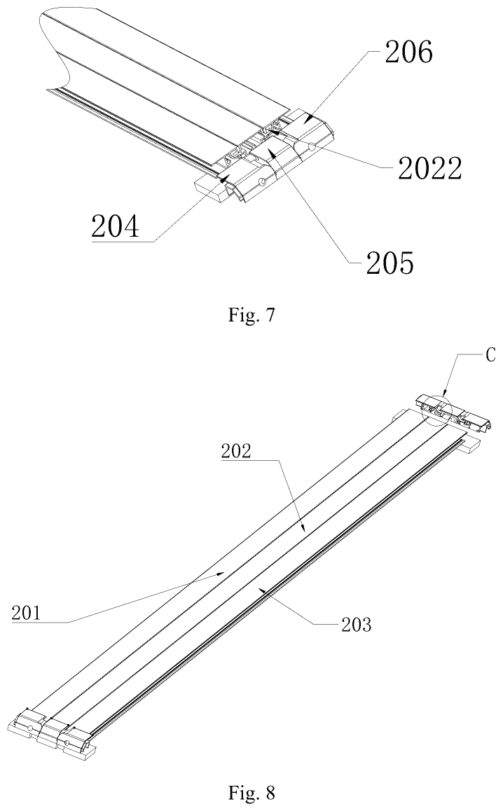

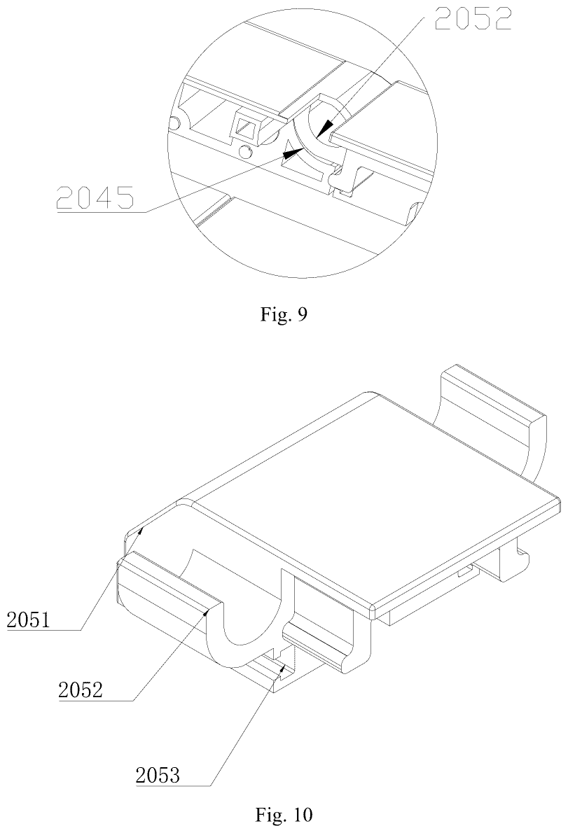

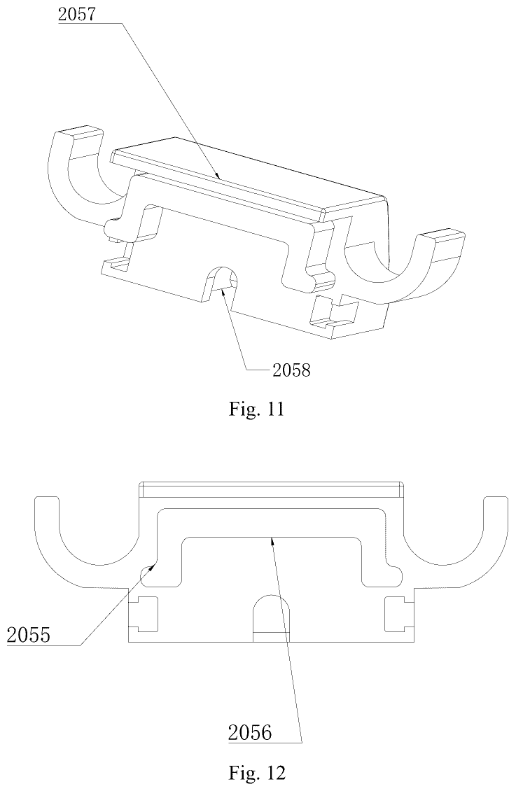

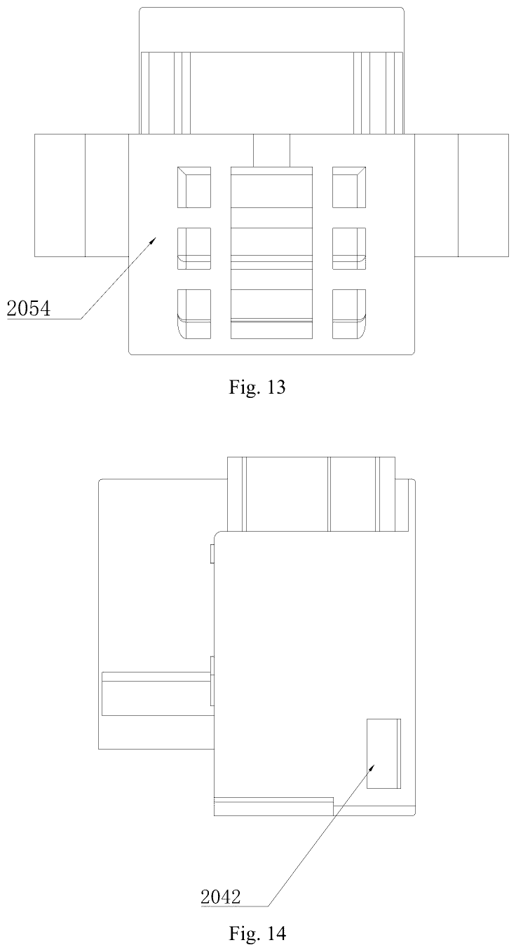

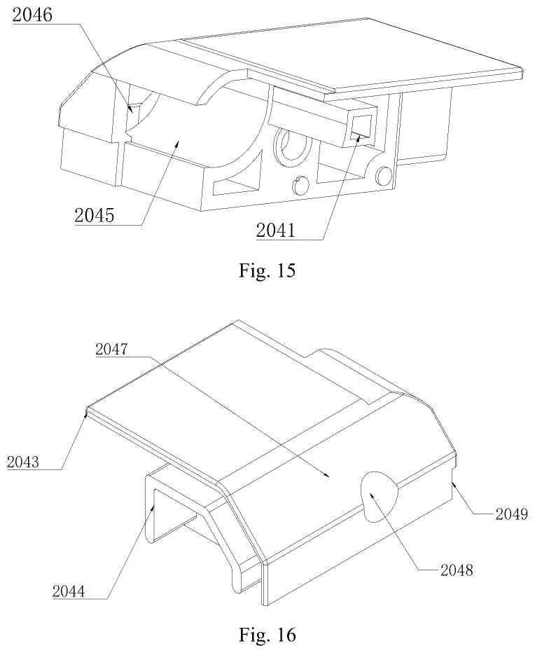

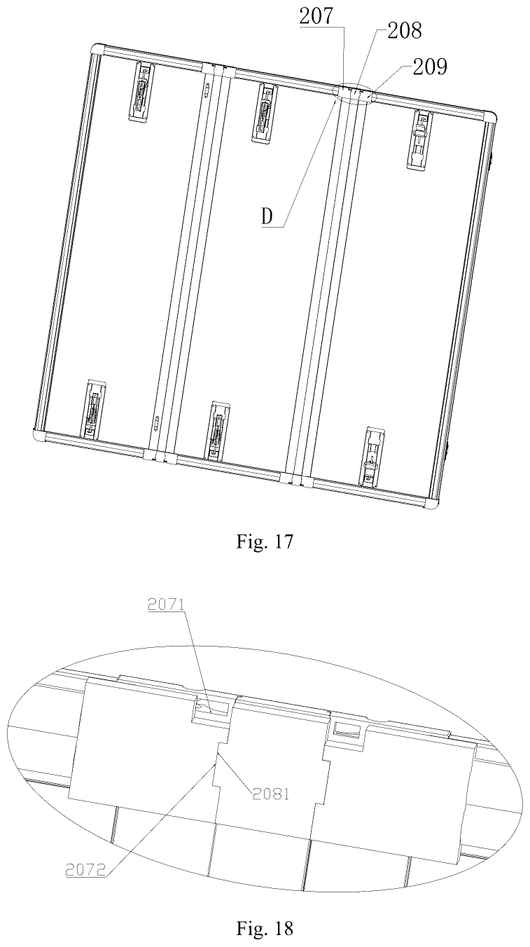

As shown in FIGS. 1-5, 7-18, a waterproof hard cover comprises a front bar 1, a first rotating shaft 2, a second rotating shaft 3, a rear bar 4, a side bar system 5, a large plate fixing system 6, a wrench fixing system 7 and a plurality of plate bodies 8;

The front bar 1, the first rotating shaft 2, the second rotating shaft 3 and the rear bar 4 form a transverse frame, the side rail system 5 forms a longitudinal frame, the transverse frame and the longitudinal frame compose the skeleton of the cover, the large plate fixing system 6 and the wrench fixing system 7 are connected to the plate bodies 8;

The first rotating shaft 2 comprises a first rotating shaft left rod 201, a first rotating shaft intermediate rod 202, a first rotating shaft right rod 203, a first rotating shaft left rod joint 204, a first rotating shaft intermediate joint 205, a first rotating shaft right rod joint 206, a first rotating shaft right rod right joint spacer 207, a first rotating shaft intermediate rod right joint spacer 208, and a first rotating shaft left rod joint spacer 209;

The first rotating shaft left rod 201 is provided with a first rotating shaft left rod blocking hook 2011 and a first rotating shaft left rod concave surface 2012, the first rotating shaft intermediate rod 202 is provided with a first rotating shaft intermediate rod round hook 2021, a first rotating shaft intermediate rod water outlet 2022 and a first rotating shaft intermediate rod C-groove 2023, the first rotating shaft left rod blocking hook 2011 is rotatably mated with the first rotating shaft intermediate rod round hook 2021, a first rotating shaft intermediate rod water outlet 2022 is provided between the first rotating shaft intermediate rod round hook 2021 and the first rotating shaft left rod blocking hook 2011, the first rotating shaft intermediate rod C-groove 2023 is adapted to the first rotating shaft left rod concave surface 2012;

The first rotating shaft intermediate joint 205 is provided with a first rotating shaft intermediate joint semi-circular hook 2052, the first rotating shaft left rod joint 204 is provided with a first rotating shaft left rod joint lower water outlet 2042, a first rotating shaft left rod joint circular arc channel 2045 and a first rotating shaft left rod joint outlet cavity 2046, the first rotating shaft intermediate joint semi-circular hook 2052 is rotationally connected to the first rotating shaft left rod joint circular arc channel 2045 (both the first rotating shaft intermediate joint semi-circular hook 2052 and the first rotating shaft left rod joint arc channel 2045 are arc shaped, the first rotating shaft intermediate joint semi-circular hook 2052 rotates inside the first rotating shaft left rod joint arc channel 2045, the center portion of the first rotating shaft intermediate joint semi-circular hook 2052 is connected with the first rotating shaft left rod joint water outlet cavity 2046 for draining water), and discharges water from the first rotating shaft intermediate rod joint lower water outlet 2042 through the first rotating shaft intermediate rod joint water outlet cavity 2046, the first rotating shaft intermediate rod water outlet 2022, the first rotating shaft intermediate rod semi-circular hook 2052, and the first rotating shaft intermediate rod joint water outlet cavity 2046 are connected to form a drainage channel.

### Embodiment 2

As shown in FIGS. 1-4, 6-18, a waterproof hard cover comprises a front bar 1, a first rotating shaft 2, a second rotating shaft 3, a rear bar 4, a side bar system 5, a large plate fixing system 6, a wrench fixing system 7 and a plurality of plate bodies 8;

The front bar 1, the first rotating shaft 2, the second rotating shaft 3 and the rear bar 4 form a transverse frame, the side rail system 5 forms a longitudinal frame, the transverse frame and the longitudinal frame compose the skeleton of the cover, the large plate fixing system 6 and the wrench fixing system 7 are connected to the plate bodies 8;

The first rotating shaft 2 comprises a first rotating shaft left rod 201, a first rotating shaft intermediate rod 202, a first rotating shaft right rod 203, a first rotating shaft left rod joint 204, a first rotating shaft intermediate joint 205, a first rotating shaft right rod joint 206, a first rotating shaft right rod right joint spacer 207, a first rotating shaft intermediate rod right joint spacer 208, and a first rotating shaft left rod joint spacer 209;

The first rotating shaft left rod 201 is provided with a first rotating shaft left rod round hook 201A1 and a first rotating shaft left rod concave surface 201A2, the first rotating shaft intermediate rod 202 is provided with a first rotating shaft intermediate rod blocking hook 202A1, a first rotating shaft intermediate rod water outlet 202A2 and a first rotating shaft intermediate rod C-groove, the first rotating shaft left rod round hook 201A1 is rotatingly mated with the first rotating shaft intermediate rod blocking hook 202A1, a first rotating shaft intermediate rod water outlet 202A2 is provided between the first rotating shaft intermediate rod blocking hook 202A1 and the first rotating shaft left rod round hook 201A1, the first rotating shaft intermediate rod C-groove 20A23 is adapted to the first rotating shaft left rod concave surface 201A2;

The first rotating shaft left joint 204 is provided with a first rotating shaft intermediate joint semi-circular hook 2052, the first rotating shaft left rod joint 204 is provided with a first rotating shaft left rod joint lower water outlet 2042, a first rotating shaft left rod joint circular arc channel 2045 and a first rotating shaft left rod joint outlet cavity 2046, the first rotating shaft intermediate joint semi-circular hook 2052 is rotationally connected to the first rotating shaft left rod joint circular arc channel 2045, and discharges water from the first rotating shaft intermediate rod joint lower water outlet 2042 through the first rotating shaft intermediate rod joint water outlet cavity 2046, the first rotating shaft intermediate rod water outlet 2022, the first rotating shaft intermediate rod semi-circular hook 2052 and the first rotating shaft intermediate rod joint water outlet cavity 2046 are connected to form a drainage channel.

### Embodiment 3

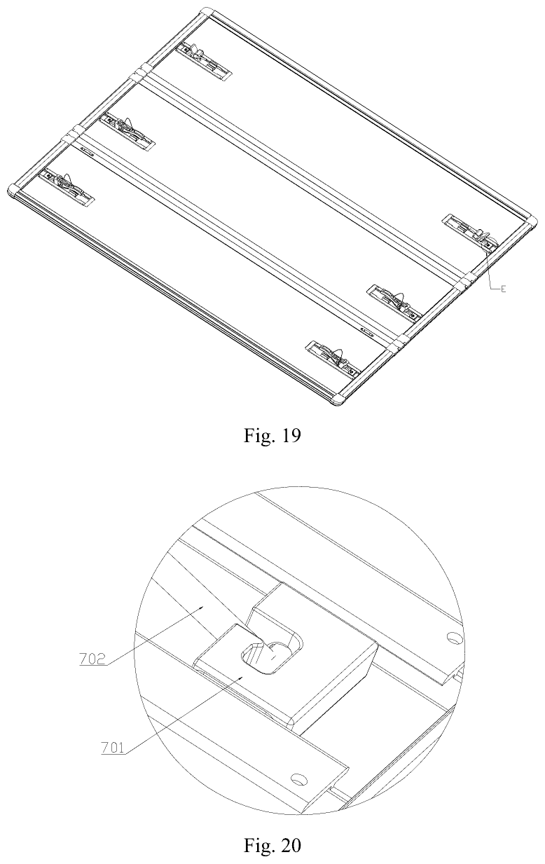

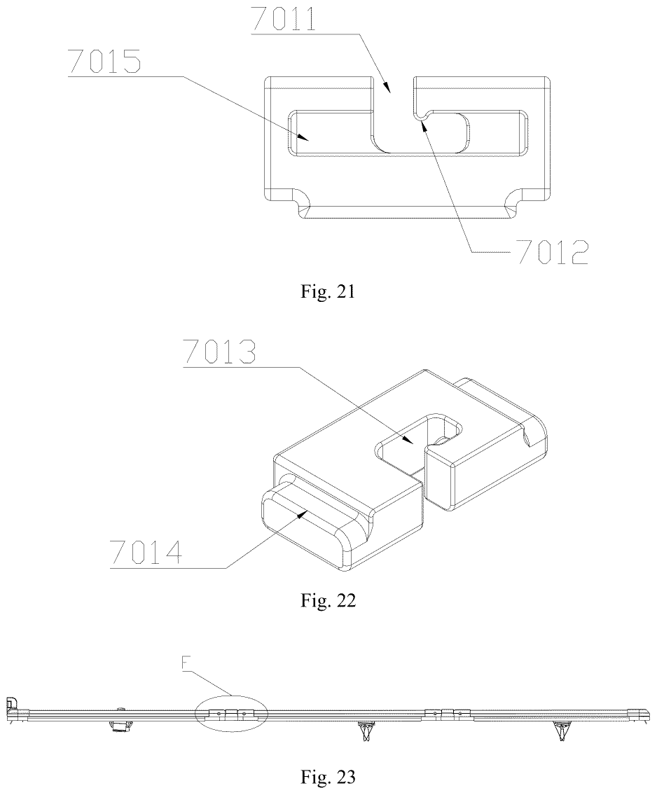

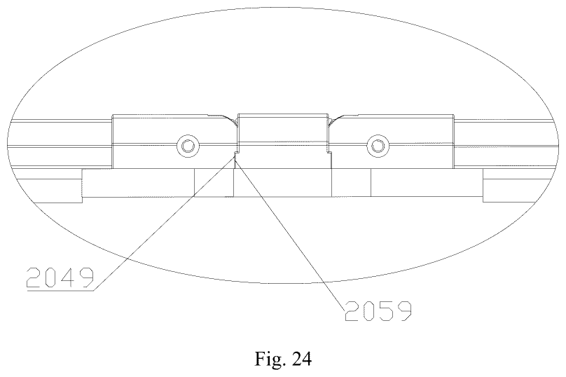

On the basis of embodiments 1 and 2, as shown in FIGS. 19-24, the first rotating shaft intermediate joint 205 further comprises a first rotating shaft intermediate joint beveled surface 2051, a first rotating shaft intermediate joint semi-circular hook 2052, a first rotating shaft intermediate joint rubber-through groove 2053, a first rotating shaft intermediate joint bottom plane 2054, a first rotating shaft intermediate joint insertion vertical portion 2055, a first rotating shaft intermediate joint insertion transverse portion 2056, a first rotating shaft intermediate joint eave 2057, a first rotating shaft intermediate joint screw hole 2058, and a first rotating shaft intermediate joint protrusion 2059;

There are two first rotating shaft intermediate joint rubber-through grooves 2053, and the two first rotating shaft intermediate joint rubber-through grooves 2053 are respectively located on both sides of the first rotating shaft intermediate joint 205, the first rotating shaft intermediate joint beveled surface 2051 is located on the front side (hereinafter referred to as the front side is the side upwardly in actual use), the first rotating shaft intermediate joint insertion vertical portion 2055 and first rotating shaft intermediate joint insertion transverse portion 2056 are inserted into the profile (first rotating shaft intermediate joint insertion vertical portion 2055 and first rotating shaft intermediate joint insertion transverse portion 2056 are of one-piece construction) for withstanding transverse and longitudinal forces, the first rotating shaft intermediate joint bottom plane 2054 is flat, the first rotating shaft intermediate joint screw holes 2058 are used for connecting the screws, the first rotating shaft intermediate joint eaves 2057 are used for covering the gap between the profile and the first rotating shaft intermediate joint 205, the first rotating shaft intermediate joint 205 is provided with a first rotating shaft intermediate joint protrusion 2059 on both sides.

### Embodiment 4

On the basis of embodiments 1 and 2, the first rotating shaft left rod joint 204 further comprises a first rotating shaft left rod joint first plug 2041, a first rotating shaft left rod joint eave 2043, a first rotating shaft left rod joint second plug 2044, a first rotating shaft left rod joint beveled surface 2047, a first rotating shaft left rod joint screw mounting holes 2048, and a first rotating shaft left rod joint concave portion 2049;

Both sides of the first rotating shaft left rod joint 204 are provided with a first rotating shaft left rod joint concave portion 2049, the first rotating shaft left rod joint first plug 2041 is used for connecting transverse profiles, the first rotating shaft left rod joint second plug 2044 is used for connecting longitudinal profiles, the first rotating shaft left rod joint 204 screw mounting is used for connecting screws, the first rotating shaft left rod joint beveled surface 2047 is provided on the front side of the first rotating shaft left rod joint 204, the first rotating shaft left rod joint eave 2043 is used to cover the gap between the profile and the joint.

### Embodiment 5

On the basis of embodiments 3 and 4, the first rotating shaft intermediate joint protrusion 2059 are staggered with the first rotating shaft left rod joint concave portioned 2049.

The first rotating shaft intermediate joint protrusions 2059 are in correspondence with the first rotating shaft left rod joint concave portion 2049 and cooperate with each other one by one.

### Embodiment 6

On the basis of embodiments 1 and 2, the first rotating shaft right rod right joint spacer 207, the first rotating shaft intermediate rod right joint spacer 208 and the first rotating shaft left rod joint spacer 209 are provided on the lower side of the first rotating shaft left rod joint 204, the first rotating shaft intermediate rod joint 205 and the first rotating shaft right rod joint 206;

The first rotating shaft right rod right joint spacer 207 is provided with a first rotating shaft right rod right joint spacer outlet notch 2071, the first rotating shaft right rod right joint spacer outlet notch 2071 is used for draining water in cooperation with the first rotating shaft left rod joint lower water outlet 2042;

The center of the first rotating shaft intermediate rod right joint spacer 208 is provided with a first rotating shaft intermediate rod intermediate joint spacer protrusion 2081, the center of the first rotating shaft right rod right joint spacer 207 is provided with a first rotating shaft intermediate rod right joint spacer concave 2072, the first rotating shaft intermediate rod intermediate joint spacer protrusion 2081 mates with the first rotating shaft intermediate rod right joint spacer concave 2072.

### Embodiment 7

On the basis of embodiments 1 and 2, both of the large plate fixing system 6 and wrench fixing system 7 are provided with a slider 701, the slider 701 is provided with a vertical notch 7011, a protrusion 7012, a transverse channel 7013, a side protrusion 7014 and a semi-circular channel 7015, there are two side protrusions 7014, the two side protrusions 7014 are provided at both ends of the slider 701, the side protrusions 7014 are used to clamp the profile and to increase the damping, the semi-circular channel 7015 is used to clamp with the T-rod 702, the semi-circular channel 7015 is used for restricting the short side of the T-rod 702, the vertical notch 7011 is used for restricting the long side of the T-rod 702.

### Embodiment 8

On the basis of embodiments 1 and 2, the first rotating shaft (2) and second rotating shaft (3) are of the same or different widths.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

What is claimed is:

1. A waterproof hard cover comprising a front bar, a first rotating shaft, a second rotating shaft, a rear bar, a side rail system, a large plate fixing system, a wrench fixing system and a plurality of plate bodies, wherein
the front bar, the first rotating shaft, the second rotating shaft and the rear bar form a transversal frame, the side rail system forms a longitudinal frame, the transversal frame and the longitudinal frame compose a skeleton of the cover, the large plate fixing system and the wrench fixing system are connected to the plate bodies;
the first rotating shaft comprises a first rotating shaft left rod, a first rotating shaft intermediate rod, a first rotating shaft right rod, a first rotating shaft left rod joint, a first rotating shaft intermediate joint, a first rotating shaft right rod joint, a first rotating shaft right rod right joint spacer, a first rotating shaft intermediate rod right joint spacer, a first rotating shaft left rod joint spacer;
the first rotating shaft left rod is provided with a first rotating shaft left rod blocking hook and a first rotating shaft left rod concave surface, the first rotating shaft intermediate rod is provided with a first rotating shaft intermediate rod round hook, a first rotating shaft intermediate rod water outlet and a first rotating shaft intermediate rod C-groove, the first rotating shaft left rod blocking hook is rotationally mated with the first rotating shaft intermediate rod round hook, a first rotating shaft intermediate rod water outlet is provided between the first rotating shaft intermediate rod round hook and the first rotating shaft left rod blocking hook, the first rotating shaft intermediate rod C-groove is adapted to the first rotating shaft left rod concave surface; and
the first rotating shaft intermediate joint is provided with a first rotating shaft intermediate joint semi-circular hook, the first rotating shaft left rod joint is provided with a first rotating shaft left rod joint lower water outlet, a first rotating shaft left rod joint circular arc channel and a first rotating shaft left rod joint outlet cavity, the first rotating shaft intermediate joint semi-circular hook is rotationally connected to the first rotating shaft left rod joint arc channel and discharges water from the first rotating shaft left rod joint lower water outlet through the first rotating shaft left rod joint water outlet cavity, the first rotating shaft intermediate rod water outlet, the first rotating shaft intermediate joint semi-circular hook and the first rotating shaft left rod joint water outlet cavity are connected to form a drainage channel.

2. A waterproof hard cover comprising a front bar, a first rotating shaft, a second rotating shaft, a rear bar, a side rail system, a large plate fixing system, a wrench fixing system, and a plurality of plate bodies, wherein
the front bar, the first rotating shaft, the second rotating shaft and the rear bar formed a transversal frame, the side rail system formed a longitudinal frame, the transversal frame and the longitudinal frame composed a skeleton of the cover, and the large plate fixing system and the wrench fixing system were connected to the plate bodies;
the first rotating shaft comprises a first rotating shaft left rod, a first rotating shaft intermediate rod, a first rotating shaft right rod, a first rotating shaft left rod joint, a first rotating shaft intermediate joint, a first rotating shaft right rod joint a first rotating shaft right rod right joint spacer, a first rotating shaft intermediate rod right joint spacer, a first rotating shaft left rod joint spacer;
the first rotating shaft left rod is provided with a first rotating shaft left rod round hook and a first rotating shaft left rod concave surface, the first rotating shaft intermediate rod is provided with a first rotating shaft intermediate rod blocking hook, a first rotating shaft intermediate rod water outlet, and a first rotating shaft intermediate rod C-groove, the first rotating shaft left rod round hook is rotationally mated with the first rotating shaft intermediate rod blocking hook, the first rotating shaft intermediate rod water outlet is rotationally mated between the first rotating shaft intermediate rod blocking hook and the first rotating shaft intermediate round rod. the first rotating shaft intermediate rod C-groove is adapted to the first rotating shaft left rod concave surface; and
the first rotating shaft left joint is provided with a first rotating shaft intermediate joint semi-circular hook, the first rotating shaft left rod joint is provided with a first rotating shaft left rod joint lower water outlet, a first rotating shaft left rod joint circular arc channel, and a first rotating shaft left rod joint outlet cavity, the first rotating shaft intermediate joint semi-circular hook is rotationally connected to the first rotating shaft left rod joint arc channel and discharges water from the first rotating shaft left rod joint lower water outlet through the first rotating shaft left rod joint water outlet cavity, the first rotating shaft intermediate rod water outlet, the first rotating shaft intermediate joint semi-circular hook and the first rotating shaft left rod joint water outlet cavity are connected to form a drainage channel.

3. The waterproof hard cover according to claim 1, wherein the first rotating shaft intermediate joint further comprises a first rotating shaft intermediate joint beveled surface, a first rotating shaft intermediate joint semi-circular hook, a first rotating shaft intermediate joint rubber-through groove, a first rotating shaft intermediate joint bottom plane, a first rotating shaft intermediate joint insertion vertical portion, a first rotating shaft intermediate joint insertion transverse portion, a first rotating shaft intermediate joint eave, a first rotating shaft intermediate joint screw hole, and a first rotating shaft intermediate joint protrusion;
there are two first rotating shaft intermediate joint rubber-through grooves, the two first rotating shaft intermediate joint rubber-through grooves are respectively located on both sides of the first rotating shaft intermediate joint, the first rotating shaft intermediate joint beveled surface is located on a front side of the first rotating shaft intermediate joint (hereinafter referred to as the front side is the side upwardly in actual use), the first rotating shaft intermediate joint insertion vertical portion and first rotating shaft intermediate joint insertion transverse portion are inserted into the profile for withstanding transverse and longitudinal forces, the first rotating shaft intermediate joint bottom plane is flat, the first rotating shaft intermediate joint screw holes are used for connecting the screws, the first rotating shaft intermediate joint eaves are used for covering the gap between the profile and the first rotating shaft intermediate joint, the first rotating shaft intermediate joint is provided with first rotating shaft intermediate joint protrusions on both sides.

4. The waterproof hard cover according to claim 1, wherein the first rotating shaft left rod joint further comprises a first rotating shaft left rod joint first plug, a first rotating shaft left rod joint eave, a first rotating shaft left rod joint second plug, a first rotating shaft left rod joint beveled surface, a first rotating shaft left rod joint screw mounting holes and a first rotating shaft left rod joint concave portion; and
both sides of the first rotating shaft left rod joint are provided with a first rotating shaft left rod joint concave portion, the first rotating shaft left rod joint first plug is used for connecting transverse profiles, the first rotating shaft left rod joint second plug is used for connecting longitudinal profiles, the first rotating shaft left rod joint screw is used for connecting screws, the first rotating shaft left rod joint beveled surface is provided on a front side of the first rotating shaft left rod joint, the first rotating shaft left rod joint eave is used to cover the gap between the profile and the joint.

5. A waterproof hard cover according to claim 3, wherein the first rotating shaft intermediate joint protrusion is staggered with the first rotating shaft left rod joint concave portion.

6. The waterproof hard cover according to claim 4, wherein the first rotating shaft intermediate joint protrusion is staggered with the first rotating shaft left rod joint concave portion.

7. The waterproof hard cover according to claim 1, wherein the first rotating shaft right rod right joint spacer, the first rotating shaft intermediate rod right joint spacer and the first rotating shaft left rod joint spacer are provided on the lower side of the first rotating shaft left rod joint, the first rotating shaft intermediate joint and the first rotating shaft right rod joint;
the first rotating shaft right rod right joint spacer is provided with a first rotating shaft right rod right joint spacer outlet notch, the first rotating shaft right rod right joint spacer outlet notch is used for draining water in cooperation with the first rotating shaft left rod joint lower water outlet; and
the center of the first rotating shaft intermediate rod right joint spacer is provided with a first rotating shaft intermediate rod intermediate joint spacer protrusion, the center of the first rotating shaft right rod right joint spacer is provided with a first rotating shaft right joint spacer concave, the first rotating shaft intermediate rod intermediate joint spacer protrusion mates with the first rotating shaft intermediate rod right joint spacer concave.

8. The waterproof hard cover according to claim 1, wherein both of the large plate fixing system and the wrench fixing system are provided with a slider, the slider is provided with a vertical notch, a protrusion, a transverse channel, a side protrusion and a semi-circular channel, there are two side protrusions, the two side protrusions are located at both end of the slider, the side protrusions are used to clamp the profile and to increase the damping, the semi-circular channel is used to clamp with the T-rod, the semi-circular channel is used for restricting the short side of the T-rod, the vertical notch is for restricting the long side of the T-rod.

9. The waterproof hard cover according to claim 1, wherein the first rotating shaft and second rotating shaft are of the same or different widths.

10. The waterproof hard cover according to claim 2, wherein the first rotating shaft intermediate joint further comprises a first rotating shaft intermediate joint beveled surface, a first rotating shaft intermediate joint semi-circular hook, a first rotating shaft intermediate joint rubber-through groove, a first rotating shaft intermediate joint bottom plane, a first rotating shaft intermediate joint insertion vertical portion, a first rotating shaft intermediate joint insertion transverse portion, a first rotating shaft intermediate joint eave, a first rotating shaft intermediate joint screw hole, and a first rotating shaft intermediate joint protrusion;
there are two first rotating shaft intermediate joint rubber-through grooves, the two first rotating shaft intermediate joint rubber-through grooves are respectively located on both sides of the first rotating shaft intermediate joint, the first rotating shaft intermediate joint beveled surface is located on a front side of the first rotating shaft intermediate joint (hereinafter referred to as the front side is the side upwardly in actual use), the first rotating shaft intermediate joint insertion vertical portion and first rotating shaft intermediate joint insertion transverse portion are inserted into the profile for withstanding transverse and longitudinal forces, the first rotating shaft intermediate joint bottom plane is flat, the first rotating shaft intermediate joint screw holes are used for connecting the screws, the first rotating shaft intermediate joint eaves are used for covering the gap between the profile and the first rotating shaft intermediate joint, the first rotating shaft intermediate joint is provided with first rotating shaft intermediate joint protrusions on both sides.

11. The waterproof hard cover according to claim 2, wherein the first rotating shaft left rod joint further comprises a first rotating shaft left rod joint first plug, a first rotating shaft left rod joint eave, a first rotating shaft left rod joint second plug, a first rotating shaft left rod joint beveled surface, a first rotating shaft left rod joint screw mounting holes and a first rotating shaft left rod joint concave portion; and
both sides of the first rotating shaft left rod joint are provided with a first rotating shaft left rod joint concave portion, the first rotating shaft left rod joint first plug is used for connecting transverse profiles, the first rotating shaft left rod joint second plug is used for connecting longitudinal profiles, the first rotating shaft left rod joint screw is used for connecting screws, the first rotating shaft left rod joint beveled surface is provided on a front side of the first rotating shaft left rod joint, the first rotating shaft left rod joint eave is used to cover the gap between the profile and the joint.

12. The waterproof hard cover according to claim 10, wherein the first rotating shaft intermediate joint protrusion is staggered with the first rotating shaft left rod joint concave portion.

13. The waterproof hard cover according to claim 11, wherein the first rotating shaft intermediate joint protrusion is staggered with the first rotating shaft left rod joint concave portion.

14. The waterproof hard cover according to claim 2, wherein the first rotating shaft right rod right joint spacer, the first rotating shaft intermediate rod right joint spacer and the first rotating shaft left rod joint spacer are provided on the lower side of the first rotating shaft left rod joint, the first rotating shaft intermediate joint and the first rotating shaft right rod joint;
the first rotating shaft right rod right joint spacer is provided with a first rotating shaft right rod right joint spacer outlet notch, the first rotating shaft right rod right joint spacer outlet notch is used for draining water in cooperation with the first rotating shaft left rod joint lower water outlet; and
the center of the first rotating shaft intermediate rod right joint spacer is provided with a first rotating shaft intermediate rod intermediate joint spacer protrusion, the center of the first rotating shaft right rod right joint spacer is provided with a first rotating shaft right joint spacer concave, the first rotating shaft intermediate rod intermediate joint spacer protrusion mates with the first rotating shaft intermediate rod right joint spacer concave.

15. The waterproof hard cover according to claim 2, wherein both of the large plate fixing system and the wrench fixing system are provided with a slider, the slider is provided with a vertical notch, a protrusion, a transverse channel, a side protrusion and a semi-circular channel, there are two side protrusions, the two side protrusions are located at both end of the slider, the side protrusions are used to clamp the profile and to increase the damping, the semi-circular channel is used to clamp with the T-rod, the semi-circular channel is used for restricting the short side of the T-rod, the vertical notch is for restricting the long side of the T-rod.

16. The waterproof hard cover according to claim 2, wherein the first rotating shaft and second rotating shaft are of the same or different widths.
